(19) United States
(12) Patent Application Publication
(10) Pub. No.: US 2026/0150790 A1
(43) Pub. Date: Jun. 4, 2026

(54) PLANT POT

(71) Applicant: Thrive Planters LLC, San Francisco, CA (US)

(72) Inventors: Michele Fried, San Francisco, CA (US); Avi Hecht, San Francisco, CA (US)

(73) Assignee: Thrive Planters LLC, San Francisco, CA (US)

(21) Appl. No.: 19/459,700

(22) Filed: Jan. 26, 2026

Related U.S. Application Data
(63) Continuation-in-part of application No. 18/745,285, filed on Jun. 17, 2024.

(51) Int. Cl. A01G 9/02

(52) U.S. Cl. CPC A01G 9/02

(57) ABSTRACT

A plant pot including a circular base having a base upper portion and a base lower portion is disclosed. The plant pot includes a pot body attached to a first predefined part of a perimeter of the base upper portion. The pot body includes a pot body top portion and a pot body bottom portion, and the pot body top portion includes a slot. The pot body includes a transparent window attached to a second predefined part of the perimeter. The transparent window engages with the pot body to define a housing of the plant pot. The transparent window is configured to engage with the slot when the transparent window engages with the pot body. The pot body includes a door attached to the pot body. The door may move between a door open state and a door closed state to cover or uncover the transparent window.

### CROSS-REFERENCE TO RELATED APPLICATION

The present application is a continuation-in-part application of U.S. application Ser. No. 18/745,285, filed Jun. 17, 2024, which is hereby incorporated by reference herein in its entirety.

### TECHNICAL FIELD

The present disclosure relates to a plant pot.

### BACKGROUND

Keeping a plant alive can be challenging, especially when it is unclear what is happening under the soil surface. Plants have different watering needs with some preferring completely dry soil between watering intervals, while others prefer continually moist soil one to two inches below the soil surface. Both overwatering and underwatering can inhibit plant growth and cause a plant to die. Thus, there exists a need for a plant pot that enables the user to see the soil moisture and more confidently know when it is time to water.

Roots typically like to grow in the dark away from harmful UV light, yet being able to observe plant roots helps determine root development and repotting needs. If the roots have grown to the point that the plant becomes rootbound, the plant's health can be compromised and it is time to repot the plant. Thus, there is a need for a plant pot that enables the user to see root development while protecting plant roots from harmful light.

Repotting can be harmful to a plant as the leaves and/or roots can be damaged when the plant is removed. Additionally, repotting can be difficult for a user when a plant is rootbound as removal of the plant from the pot can be challenging. Thus, there is a need for a plant pot that provides better plant protection and easy plant removal during the repotting process.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example plant pot with a device door in an open state in accordance with the present disclosure.

FIG. 2 depicts the plant pot of FIG. 1 with the device door in a closed state in accordance with the present disclosure.

FIG. 3 depicts an example of shade movement in the plant pot of FIG. 1 in accordance with the present disclosure.

FIG. 4 depicts an example exploded view of the plant pot of FIG. 1 in accordance with the present disclosure.

FIG. 5 depicts a first connection between the door and the shade in the plant pot of FIG. 1 in accordance with the present disclosure.

FIG. 6 depicts a second connection between the door and the shade in the plant pot of FIG. 1 in accordance with the present disclosure.

FIG. 7 depicts an alternative embodiment of the plant pot in accordance with the present disclosure.

FIG. 8 depicts an isometric view of a plant pot in a first configuration in accordance with the present disclosure.

FIG. 9 depicts a front view of the plant pot in the first configuration in accordance with the present disclosure.

FIG. 10 depicts an isometric view of a plant pot in a second configuration in accordance with the present disclosure.

FIG. 11 depicts a front view of the plant pot in the second configuration in accordance with the present disclosure.

FIGS. 12A and 12B depict a plant pot with door stoppers in accordance with the present disclosure.

FIG. 13 depicts a shade and a device door with detents to engage the shade with the device door in accordance with the present disclosure.

### DETAILED DESCRIPTION

### Overview

The present disclosure is directed towards a plant pot that may include a base and a hollow cylindrical body connected to the base. The cylindrical body may be configured to hold soil and a plant. The cylindrical body may be partially made of an opaque pot body and a transparent body (e.g., a transparent window). In an exemplary aspect, a half portion of the cylindrical body may be made of opaque material, and the other half portion may be made of transparent material. The opaque pot body may be removably attached to the transparent window. Further, the transparent window may be removably attached to the base.

The plant pot may further include a door that may be pivotally connected to the pot body via a hinge, and may be configured to cover or uncover the transparent window. The door may be configured to move between a door closed state and a door open state. In the closed state, the door may be placed over the transparent window outer surface to cover the transparent window to enable the roots to grow in a dark environment. In the door open state, the door may uncover the transparent window to enable a user to see the soil state or plant root state.

In some aspects, the door may include a cut-out that may be located at a door middle portion or a door side portion. The plant pot may further include a shade that may be configured to cover or uncover the cut-out. In some aspects, the door may include a rail that enables the shade to slide on the door to cover or uncover the cut-out. The shade may be removably connected to a door upper edge and/or a door lower edge. In some aspects, the shade may be sandwiched between the transparent window and the door. In such cases, the shade may include a tab that may be accessed by the user to slide the shade to cover or uncover the cut-out.

In some aspects, a pot body top portion may include a slot that may facilitate retaining of the transparent window in the plant pot. The slot may provide support to the transparent window top portion and facilitate retaining of the transparent window in the plant pot. The transparent window may engage with the slot located at the pot body top portion when the transparent window engages with the pot body. In some aspects, the transparent window top portion may be inserted in the slot to retain the transparent window. In other aspects, the transparent window top portion may rest against the slot to form a ventilation channel along the side edges of the pot body.

It may be appreciated that the ventilation channel in the plant pot enhances root-zone aeration by allowing fresh air to circulate through the soil profile, which helps maintain an optimal balance of oxygen and moisture around the roots. This improved airflow prevents soil compaction, reduces the risk of root rot caused by excessive water retention, and supports healthier microbial activity that contributes to nutrient availability. By facilitating faster evaporation of excess moisture, the ventilation channel also aids in regulating soil temperature and promotes stronger, more resilient root development, ultimately leading to healthier plant growth and reduced maintenance issues.

The present disclosure discloses a plant pot that enables a user to conveniently view/determine the soil state and accordingly better know when to add water to the plant. In addition, the plant pot allows the roots to grow in a dark environment. Furthermore, the plant pot enables the user to easily clean all the plant pot components and more easily and less harmfully remove the existing plant for repotting.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

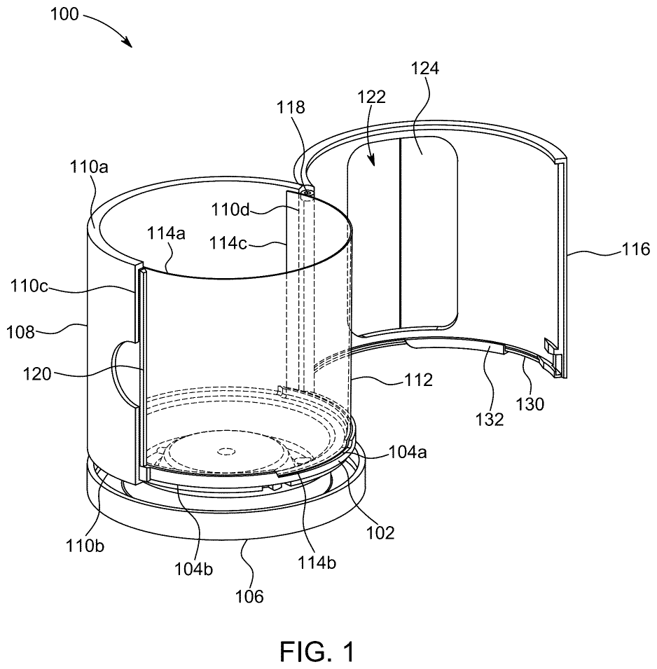

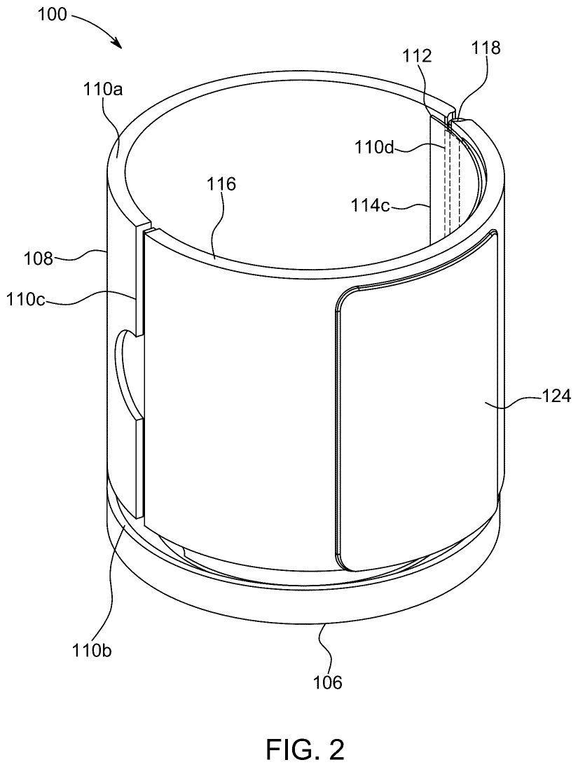

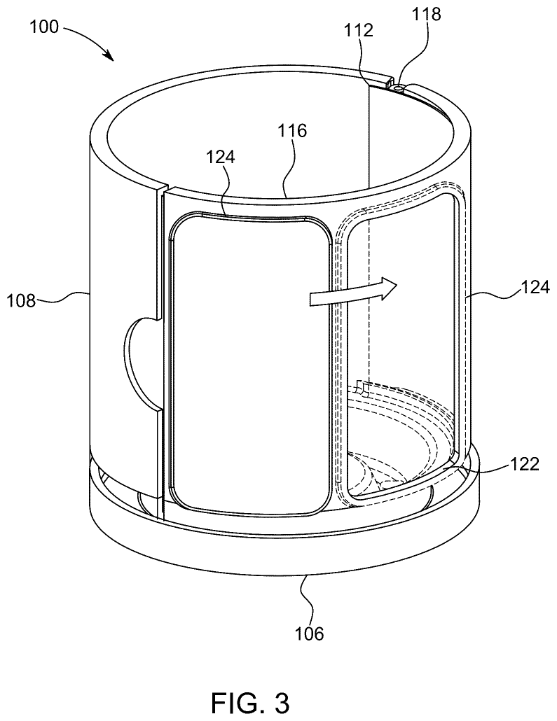

FIG. 1 depicts an example of the plant pot with a device door in an open state in accordance with the present disclosure. FIG. 1 will be described in conjunction with FIG. 2, and also in conjunction with FIGS. 3-6.

The plant pot 100 may be used by a user to grow and water plants. The plant pot 100 may enable the user to optimally water the plants, so that the plants are not overwatered or under-watered. In some aspects, the plant pot 100 may be a multi-piece device having a plurality of components that may be assembled together, as described below.

The plant pot 100 may include a base 102. The base 102 may be a circular/cylindrical body that may be made of any material such as plastic, metal, etc. The base 102 may have any dimension, based on the expected dimensions of the plant needed to be watered/grown in the plant pot 100. The base 102 may include a base upper portion 104a and a base lower portion 104b. The base lower portion 104b may be configured to be positioned on the ground. In alternative aspects, the base lower portion 104b may be configured to be mounted on a saucer 106 that may be secured/placed on the ground. The saucer 106 may include a saucer cavity (not shown) that may be configured to receive the base lower portion 104b.

In some aspects, the base 102 may be a hollow body having a closed end at the base lower portion 104b, and an open end at the base upper portion 104a. In some aspects, a base diameter at the base upper portion 104a may be the same as a base diameter at the base lower portion 104b. Alternatively, the base diameter at the base upper portion 104a may be greater than the base diameter at the base lower portion 104b. In an exemplary aspect, the base diameter at the base lower portion 104b may correspond to a saucer cavity diameter.

The plant pot 100 may further include a main pot body 108 (or pot body 108) that may be attached to the base upper portion 104a. In some aspects, the pot body 108 may be integrated or permanently attached to the base 102. Alternatively, the pot body 108 may be removably connected to the base 102. The pot body 108 may be an opaque body and may be made of any material such as plastic, metal, etc. The opaque body may not allow light to pass through, and may thus facilitate the roots of the plant (disposed inside the plant pot 100) to grow in the dark. The pot body 108 may be an elongated hollow semicircular body (or hollow semi-cylindrical body) having a pot upper edge 110a, a pot lower edge 110b, and pot side edges 110c, 110d. The pot lower edge 110b may be attached to the base upper portion 104a. In some aspects, the pot body 108 may have a constant diameter throughout a pot body height, as shown in FIG. 1. The pot body diameter may be the same as the base diameter at the base upper portion 104a. Alternatively, the pot body 108 may have a first diameter towards the pot lower edge 110b and a second diameter towards the pot upper edge 110a; the second diameter being greater than the first diameter. In further aspects, the pot body 108 may have open ends at the upper and lower portions (e.g., at the pot upper edge 110a and the pot lower edge 110b). In further aspects, the pot body 108 may be of any other shape including, but not limited to, square, rectangular, and/or the like.

The plant pot 100 may further include a transparent window 112 that may be attached to the base upper portion 104a. In some aspects, the transparent window 112 may be attached to the other half of the base upper portion 104a, opposite to the half on which the pot body 108 may be attached to the base upper portion 104a. Collectively, the pot body 108 and the transparent window 112 may form a hollow cylindrical structure on top of the base upper portion 104a. In further aspects, the transparent window 112 may be of any other shape including, but not limited to, square, rectangular, and/or the like.

The transparent window 112 enables the user to view the state of soil/plant roots, when the plant may be growing in the soil placed in the pot body 108. As an example, the transparent window 112 enables the user to see whether the soil is dry or wet, or whether the plant roots require water. The user may view the soil state, and accordingly provide the adequate amount of water to the plant. In this manner, the plant pot 100 enables the user to optimally water the plant that is being grown in the plant pot 100.

The transparent window 112 may be an elongated semicircular body having a window upper edge 114a, a window lower edge 114b, and window side edge 114c. The window lower edge 114b may be attached to the base upper portion 104a. In some aspects, the transparent window dimensions may be the same as the pot body dimensions. For example, a pot body 108 height may be the same as a transparent window 112 height. Further, a pot body 108 diameter may be substantially the same as or equivalent to a transparent window 112 diameter. Alternatively, the transparent window dimensions may be different from the pot body dimensions. For example, the pot body 108 diameter may be slightly greater than the transparent window 112 diameter. In some aspects, the transparent window 112 may have a constant diameter throughout a transparent window height, as shown in FIG. 1. The transparent window 112 diameter may be the same as the base diameter at the base upper portion 104a. Alternatively, the transparent window 112 may have a first diameter towards the window lower edge 114b and a second diameter towards the window upper edge 114a; the second diameter being greater than the first diameter. In further aspects, the transparent window 112 may have open ends at the upper and lower portions (e.g., at the window upper edge 114a and the window lower edge 114b).

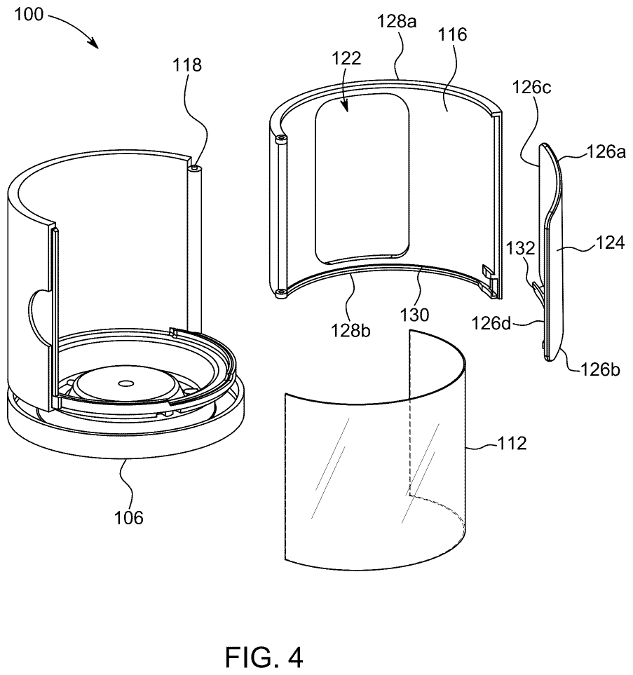

In some aspects, the transparent window 112 may be removably connected to the base 102 (as shown in FIG. 4), which allows the user to easily remove the plant for repotting, and clean the plant pot 100. The base upper portion 104a may include pockets or slots that may be configured to receive the transparent window 112 and/or the pot body 108. The pot body 108 may be disposed on a first part of the base upper portion 104a, and the transparent window 112 may be disposed on a second part of the pot body 108. The first part and the second part may be opposite to each other on the base upper portion 104a, and may not overlap. Specifically, the pot lower edge 110b may be attached to a first half part (or a first semi-circle) of the base upper portion 104a, and the window lower edge 114b may be attached to a second half part (or a second semi-circle) of the base upper portion 104a. The pot body 108 and the transparent window 112 may be attached to equal parts of the base upper portion 104a. In alternative aspects (not shown), the pot body 108 and the transparent window 112 may be attached to unequal parts of the base upper portion 104a.

In some aspects, the base upper portion 104a may include concentric pockets or slots to receive the transparent window 112 and/or the pot body 108. The concentric pockets may include inner pockets located at a first base radius, and outer pockets located at a second base radius. The second base radius may be greater than the first base radius. The pot body 108 may be disposed in the outer pockets, and the transparent window 112 may be disposed in the inner pockets. When the pot body 108 and the transparent window 112 are engaged in the outer pockets and the inner pockets respectively, the pot side edges 110c, 110d may be positioned in proximity to (and may contact) the respective window side edges. In some aspects, when the pot body 108 and the transparent window 112 are engaged in the outer pockets and the inner pockets respectively, the pot side edge 110c may overlap (or be disposed one over the other) with the window side edge 114c, and the pot side edge 110d may overlap with the other window side edge, which may prevent leakage of soil/water from the interior portion of the cylindrical structure formed by the pot body 108 and the transparent window 112.

A person ordinarily skilled in the art may appreciate from the description above that the pot body 108 and the transparent window 112 may form a hollow cylinder (the interior portion of which may be configured to receive the plant, soil, water, etc.), when the pot body 108 and the transparent window 112 are connected to the base 102. A diameter of the hollow interior portion may be the same throughout the height of the cylinder. Alternatively, the diameter of the hollow interior portion towards the pot upper edge 110a and the window upper edge 114a may be greater than the diameter of the hollow interior portion towards the pot lower edge 110b and the window lower edge 114b.

The plant pot 100 may further include a door 116 that may be attached to the pot body 108, and configured to cover or uncover the transparent window 112. The door 116 may be configured to cover an outer face (or front portion/exterior surface) of the transparent window 112. The outer face may be opposite to an inner face of the transparent window 112 that faces the pot body 108. The door 116 may be a semicircular body having dimensions similar to the transparent window 112 dimensions, and may be configured to completely cover/surround/enclose the transparent window 112. For example, a door 116 height may be equivalent to the transparent window 112 height. Further, a door 116 diameter may be equivalent to or slightly greater than the transparent window 112 diameter. The door 116 may be made of any material. For example, the door 116 may be made of plastic or any metal such as aluminum, steel, etc. In some aspects, the door 116 may be made of an opaque material that prevents light from passing through. The door 116 may prevent light from passing through the transparent window 112 when the transparent window 112 may be completely covered by the door 116. The user may uncover the transparent window 112 by opening the door 116, to view the soil state or roots through the transparent window 112.

In some aspects, the door 116 may be removably connected to the pot body 108 (as shown in FIG. 4). In an exemplary aspect, the door 116 may be pivotally attached to the pot body 108 via a hinge 118 (located at the pot side edge 110c or 110d). The hinge 118 may be a piano hinge, a living hinge, a clip-in hinge, a snap-in hinge, and/or the like. The door 116 may be pivotally attached to the pot body 108 via a hinge 118 such that the door 116 may axially rotate about the edge having the hinge 118 (e.g., the pot side edge 110c or 110d).

The door 116 may be configured to move between a door closed state and a door open state. In the door closed state, the door 116 may be configured to completely cover or enclose the transparent window 112 (e.g., the outer face of the transparent window 112). Specifically, in the door closed state, the door 116 may be positioned in proximity to the transparent window outer face/surface to completely cover/surround the transparent window 112, as shown in FIG. 2. In the door open state, the door 116 may be located away from the transparent window outer face/surface to uncover the transparent window 112, as shown in FIG. 1.

In further aspects, the pot body 108 may include a latching mechanism (e.g., a latch 120) that may be configured to hold or lock the door 116 in the door closed state. The latch 120 may be located at the pot side edge 110c or 110d that is opposite to the pot side edge that includes the hinge 118, and may be configured to hold/lock the door 116 in the door closed state. The use may pull the door 116 to move the door 116 from the door closed state to the door open state (e.g., to detach the door 116 from the pot body 108 via the latch 120). The latch 120 may be located in proximity to a door side edge that is opposite to the door side edge that is connected to the pot body 108 via the hinge 118. Stated another way, one door side edge may be connected to the pot body 108 via the hinge 118, and the other door side edge (which may be diametrically opposite to the door side edge described above) may be detachably connected to the pot body 108 via the latch 120.

In addition or alternative to the latching mechanism, the plant pot 100 may include magnets to removably attach the door 116 to the pot body 108. In some aspects, the door 116 may include magnets on one door side edge opposite to the other door side edge that is attached to the pot body 108 via the hinge 118. In further aspects, the door 116 may include magnets on both the door side edges. In the latter scenario, the plant pot 100 may not include the hinge 118, and the door 116 may be attached to the pot body 108 via the magnets. In further aspects, the pot body 108 may include corresponding magnets or ferrous material to hold the door 116 in the door closed state.

Furthermore, the door 116 may include a cut-out 122 (or an opening) that may be located at any position on the door 116 body. In some aspects, the cut-out 122 may be located at a door center portion. In other aspects, the cut-out 122 may be located at a door side portion. The cut-out 122 may cover 5-85% of a total door area. The cut-out 122 may be of any shape. For example, the cut-out 122 may be rectangular. In other aspects, the cut-out 122 may be of any other shape including, but not limited to, circular, oval, square, and/or the like.

The plant pot 100 may further include a shade 124 that may be configured to cover or uncover the cut-out 122. The shade 124 may be made of any material. In an exemplary aspect, the shade 124 may be made of plastic. In some aspects, the shade 124 may be made of opaque material that may not allow light to pass through the cut-out 122 when the cut-out 122 is completely covered by the shade 124. The shade dimensions may correspond to the cut-out 122 area to enable the shade 124 to completely cover the cut-out 122.

The shade 124 may be configured to slide on the door 116 between a shade open state and a shade closed state, as depicted in FIG. 3, to cover or uncover the cut-out 122. In the shade closed state, the shade 124 may be configured to completely cover the cut-out 122, as shown in FIG. 2, to allow the plant roots to grow in the dark. In the shade open state, the shade 124 may be configured to partially or completely uncover the cut-out 122, as shown in FIG. 1, to allow the user to view the soil state or roots. A person ordinarily skilled in the art may appreciate from the description above that the shade 124 enables the user to view the soil state conveniently (e.g., when the user moves the shade 124 to the shade open state), without having to open the door 116 and view the soil state or roots via a completely-open transparent window 112. In some aspects, the shade 124 enables a quick and convenient way for the user to view the soil state or roots.

The shade 124 may have a shade upper edge 126a, a shade lower edge 126b, and shade side edges 126c, 126d, as shown in FIG. 4. In some aspects, the shade upper edge 126a may be positioned in proximity to a door upper edge 128a, and the shade lower edge 126b may be positioned in proximity to a door lower edge 128b. In some aspects, a shade height may be equivalent to or slightly less than a door height. The shade 124 may be removably attached to the door 116 in a plurality of different ways, as shown in FIGS. 4-6. Example ways of attaching the shade 124 with the door 116 are described below, which should not be construed as limiting.

In a first exemplary aspect, the shade 124 may be connected to the door 116 via the shade lower edge 126b and the door lower edge 128b, as shown in FIG. 4. In the first exemplary aspect of FIG. 4, the door 116 may include a rail 130 at a door interior surface/portion on which the shade 124 may slide between the shade open state and the shade closed state. The shade 124 may include a bracket 132 (e.g., an “L-shaped” bracket or a “U-shaped” bracket) that may be configured to engage with the rail 130 that enables the shade 124 to attach with the door 116, and slide between the shade open state and the shade closed state. In the first exemplary aspect, the bracket 132 may be located at (or towards) the shade lower edge 126b and the rail 130 may be located at (or towards) the door lower edge 128b, which enables the shade 124 to removably connect to the door 116 at the door lower edge 128b. The shade lower edge 126b may snap or latch with the door lower edge 128b, via the rail 130 and the bracket 132, enabling the shade 124 to be removably connected with the door lower edge 128b, while at the same time enabling the shade 124 to easily slide between the shade open state and the shade closed state. In this case, the shade upper edge 126a may not be connected to the door upper edge 128a.

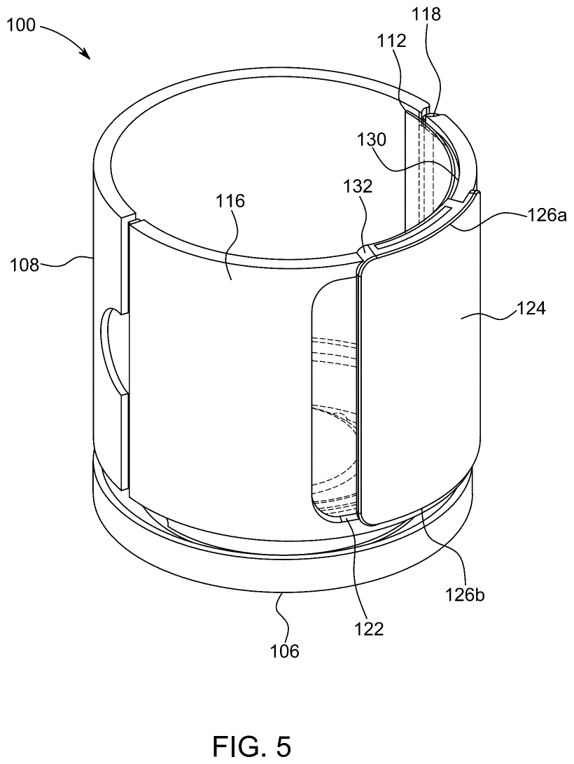

In a second exemplary aspect, instead of the shade 124 being connected to the door lower edge 128b, the shade 124 may be removably connected to the door 116 at via the door upper edge 128a, as shown in FIG. 5. In the second exemplary aspect, the bracket 132 may be located at (or towards) the shade upper edge 126a and the rail 130 may be located at (or towards) the door upper edge 128a. In some aspects, the shade upper edge 126a may snap or latch with the door upper edge 128a, via the rail 130 and the bracket 132, enabling the shade 124 to be removably connected with the door upper edge 128a, while at the same time enabling the shade 124 to easily slide between the shade open state and the shade closed state.

In alternative aspects (not shown), the door 116 may include rails at both the door upper edge 128a and the door lower edge 128b and the shade 124 may have the bracket 132 at both the shade upper edge 126a and the shade lower edge 126b, to enable slidable connection of the shade 124 at both the door upper edge 128a and the door lower edge 128b.

In both the first and secondary exemplary aspects described above, the shade 124 slides on the outer surface of the door 116, i.e., the door 116 is sandwiched between the transparent window 112 and the shade 124.

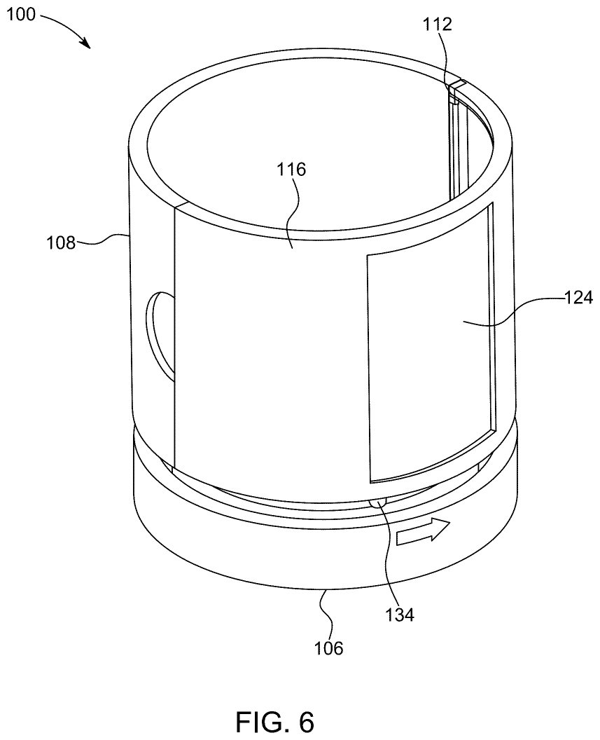

In a third exemplary aspect, instead of the door 116 being sandwiched between the transparent window 112 and the shade 124, the shade 124 may be disposed between the transparent window 112 and the door 116, as shown in FIG. 6. Stated another way, the shade 124 may be sandwiched between the transparent window 112 and the door 116. In the third exemplary aspect, the door 116 may include rails at (or towards) the door upper edge 128a, or at the door lower edge 128b, or both the door upper edge 128a and the door lower edge 128b. The shade 124 may slide between the shade open state and the shade closed state via the rails. In some aspects, the shade 124 may include a tab 134 that facilitates the user to slide the shade 124 between the shade open state and the shade closed state. The tab 134 may be a part of the shade 124 that may be accessed by the user to slide the shade 124. The tab 134 may extend outside the door to allow the user to access the tab 134. The tab 134 may be located at any position. For example, the tab 134 may be located at the shade lower portion (as shown in FIG. 6). In other aspects, the tab 134 may be located at the shade upper portion. In further aspects, the door 116 may include a first layer (e.g., an inner layer) and a second layer (e.g., an outer layer), and the shade 124 may be sandwiched between the first layer and the second layer of the door 116.

In yet another exemplary aspect, shade 124 may be removably connected to the door 116 via magnets. In some aspects, the door 116 may include magnets and the shade 124 may be made of ferrous material. In further aspects, both the door 116 and the shade 124 may include magnets that facilitate magnetic attachment between the shade 124 and the door 116.

In operation, when the user desires to view the soil state (e.g., to check whether the soil is dry or wet), the user may move the shade 124 from the shade closed state to the shade open state. The user may open the shade 124 partially or completely to view the soil state. When the user moves the shade 124 to the shade open state, the user may view the state through the transparent window 112. After viewing the soil state, the user may slide back the shade 124 from the shade open state to the shade closed state to allow the roots to grow in a dark environment. In alternative or additional aspect, the user may use the door 116 to view the soil state. In this case, the user may move the door 116 from the door closed state to door open state to view the soil state, e.g., by pulling the door 116 from the latch 120 and rotating the door 116 about the hinge 118. After viewing the soil state, the user may move back the door 116 from the door open state to the door closed state. Based on the soil state, the user may decide to water the plant (e.g., if the soil is becoming dry).

The user may further disassemble the plant pot 100 for easier repotting (e.g., to take out an existing plant from the side of the plant pot, clean the plant pot 100, and to place a plant in the plant pot 100). To disassemble the plant pot 100, the user may move the door 116 from the door closed state to the door open state, via the hinge 118. When the door 116 may be in the door open state, the user may remove the transparent window 112 (e.g., by detaching the transparent window 112 from the base upper portion 104a). The user may take out the existing plant from the interior portion, clean the interior portion, place the transparent window 112 back (e.g., attach the window lower edge 114b to the base upper portion 104a), and position a plant in the interior portion. The user may then move the door 116 from the door open state to the door closed state to allow the roots to grow in a dark environment. The user may further position the shade 124 in the shade closed position. Alternatively, the user may reassemble the transparent window 112 (e.g., attach the window lower edge 114b to the base upper portion 104a), move the door 116 from the door open state to the door closed state, and then position the plant in the interior of the device.

To perform deep cleaning, the user may further detach the door 116 from the pot body 108 (via the hinge 118). The user may also remove or detach the shade 124 from the door 116. After detaching the door 116 and/or the shade 124, the user may clean all the device components. After cleaning the components, the user may assemble the components back. For example, the user may attach the door 116 to the pot body 108, attach the shade 124 to the door 116, and so on. This way, the user may clean all the components easily, and perform the process of repotting conveniently.

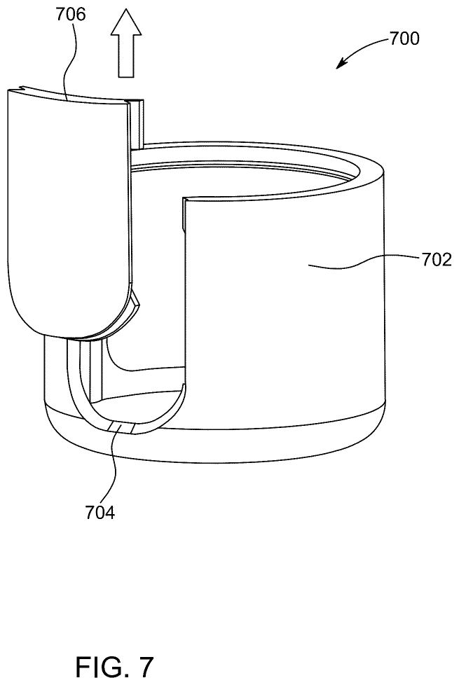

FIG. 7 depicts an alternate embodiment of a plant pot 700 in accordance with the present disclosure. In this embodiment, the plant pot 700 may include a pot body 702 that may be made of plastic or any other material. The pot body 702 may be a hollow cylindrical body configured to receive the plant. The pot body 702 may include a cut-out 704. In some aspects, a cut-out length may be the same as (or substantially equivalent to) the pot height. In other aspects, the cut-out length may be less than the pot height. The plant pot 700 may include a transparent window (not shown) that may be configured to completely cover the cut-out 704. The transparent window may be removably connected to the pot body 702. Specifically, the transparent window may be configured to slide-in and slide-out vertically to/from the cut-out 704. The dimensions of the transparent window may correspond to the dimensions of the cut-out 704. The plant pot 700 may further include a door 706 that may be configured to cover the transparent window. The door 706 may be removably connected to the pot body 702. Specifically, the door 706 may be configured to slide-in and slide-out vertically to/from the cut-out 704. The door 706 may be an opaque body and may be made of plastic or any other material. The dimensions of the door 706 may correspond to the dimensions of the transparent window. The user may pull/slide the door 706 in an upward direction to view the soil state. After viewing the soil state, the user may slide the door in a downward direction. In further aspects, the door 706 may include magnets (e.g., on door side edges), and the pot body 702 may include corresponding magnets or ferrous material to facilitate magnetic attachment of the door 706 and the pot body 702.

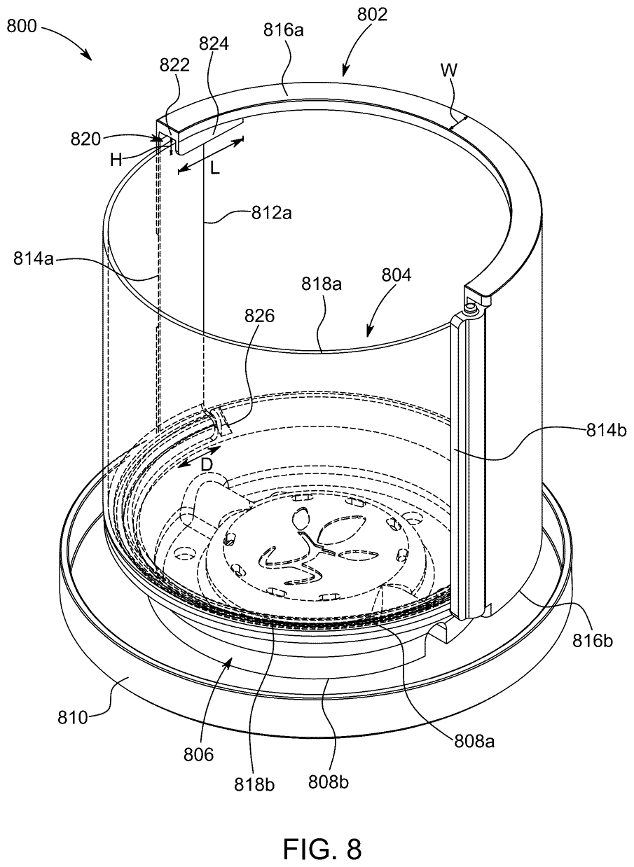

FIG. 8 depicts an isometric view of a plant pot 800 in a first configuration in accordance with the present disclosure. The plant pot 800 may be similar to the plant pot 100 described above in conjunction with FIG. 1. The plant pot 800 includes a pot body 802 and a transparent window 804. The plant pot 800 may include one or more additional components that are not shown in FIG. 8 for clarity. The pot body 802 and the transparent window 804 may be similar to the pot body 108 and the transparent window 112 respectively, described above in conjunction with FIG. 1. As described above, the pot body 802 may be an opaque body and may be made of any material such as plastic, metal, etc. The opaque body may not allow light to pass through. The transparent window 804 enables the user to view the state of soil/plant roots.

The plant pot 800 further includes a base 806 that may be similar to the base 102 described above in conjunction with FIG. 1. The base 806 may be a circular/cylindrical body that may be made of any material such as plastic, metal, etc. The base 806 may have any dimensions, based on the expected dimensions of the plant needed to be watered/grown in the plant pot 800. The base 806 may include a base upper portion 808a and a base lower portion 808b. The base lower portion 808b may be positioned on the ground or on a saucer 810 (similar to the saucer 106 described above in conjunction with FIG. 1). The base upper portion 808a creates a vertically oriented datum surface configured to establish a precise positional reference for the transparent window 804 to sit against. When the transparent window 804 is installed, a corresponding surface of the transparent window 804 is brought into direct contact with the datum surface, thereby defining its vertical alignment relative to the base upper portion 808a. This datum ensures consistent seating, prevents unintended vertical displacement, and provides a controlled reference plane for downstream assembly operations or functional interactions between the base 806 and the transparent window 804. By relying on a defined vertical datum, the assembly achieves repeatable positioning accuracy without requiring additional fasteners or adjustment mechanisms. In this embodiment, the base 806 may not include the concentric pockets to engage the pot body 802 and the transparent window 804, like the base 102 described in FIG. 1.

The pot body 802 may be attached to a first predefined part of a perimeter of the base upper portion 808a. In some aspects, the pot body 802 may be integrated to the base 806. In an exemplary aspect, the pot body 802 may be an elongated hollow semicircular body (or hollow semi-cylindrical body) that may be positioned on a first half-portion of the perimeter of the base upper portion 808 a. In this scenario, the pot body 802 may cover 50% of the perimeter of the base upper portion 808 a. Although the present disclosure describes that the pot body 802 covers 50% of the perimeter of the base upper portion 808a, the present disclosure is not limited to this dimension. It may be appreciated that the pot body 802 may cover less than or greater than 50% of the perimeter of the base upper portion 808 a. For instance, the pot body 802 may cover 20-80% of the perimeter of the base upper portion 808a.

The transparent window 804 may be attached to a second predefined part of a perimeter of the base upper portion 808a. In some aspects, the transparent window 804 may be removably attached to the base 806. In an exemplary aspect, the transparent window 804 may be an elongated hollow semicircular body (or hollow semi-cylindrical body) that may be positioned on a second half-portion of the perimeter of the base upper portion 808a. In this scenario, the transparent window 804 may cover the remaining 50% of the perimeter of the base upper portion 808a (i.e., that part of the perimeter of the base upper portion 808a that is not covered by the pot body 802). Although the present disclosure describes that the transparent window 804 covers 50% of the perimeter of the base upper portion 808 a, the present disclosure is not limited to this. It may be appreciated that the transparent window 804 may cover less than or greater than 50% of the perimeter of the base upper portion 808a, depending on the percentage of the perimeter covered by the pot body 802. For instance, the transparent window 804 may cover 20-80% of the perimeter of the base upper portion 808a, depending on the percentage of the perimeter covered by the pot body 802.

In some aspects, the second predefined part may be opposite to the first predefined part. The pot body 802 and the transparent window 804 may form a hollow cylinder (the interior portion of which may receive the plant, soil, water, etc.), when the pot body 802 and the transparent window 804 are connected to the base 806. In some aspects, the transparent window 804 may engage with the pot body 802 to define a housing of the plant pot 800, to receive the plant, soil, water, etc., when the pot body 802 and the transparent window 804 are connected to the base 806. In an exemplary aspect, side edges (e.g., edges 812a, 812b) of the transparent window 804 may overlap with side edges (e.g., edges 814a, 814b) of the pot body 802 when the pot body 802 and the transparent window 804 are connected to the base 806.

The pot body 802 may include a pot body top portion 816a and a pot body bottom portion 816b. The pot body bottom portion 816b may contact the base upper portion 808a. Similarly, the transparent window 804 may include a transparent window top portion 818a and a transparent window bottom portion 818b. The transparent window bottom portion 818b may contact the base upper portion 808a when the transparent window 804 engages with the base 806.

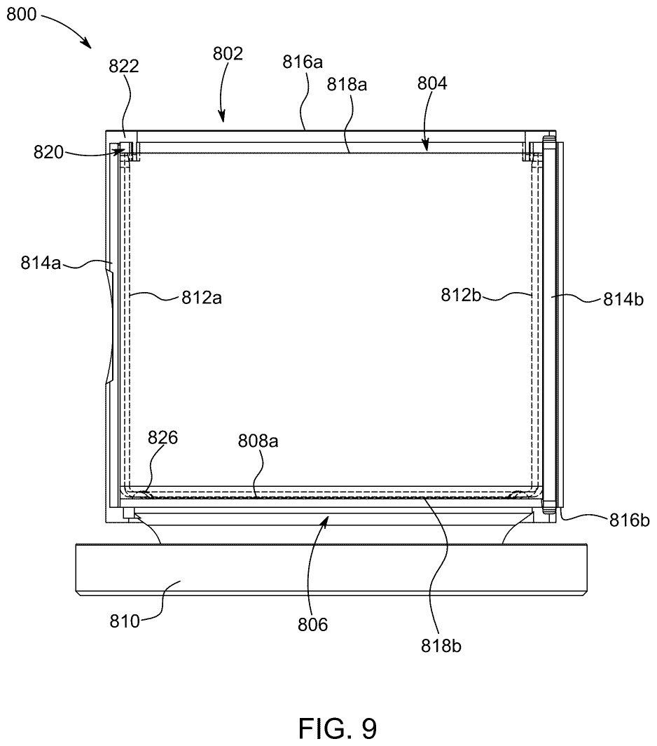

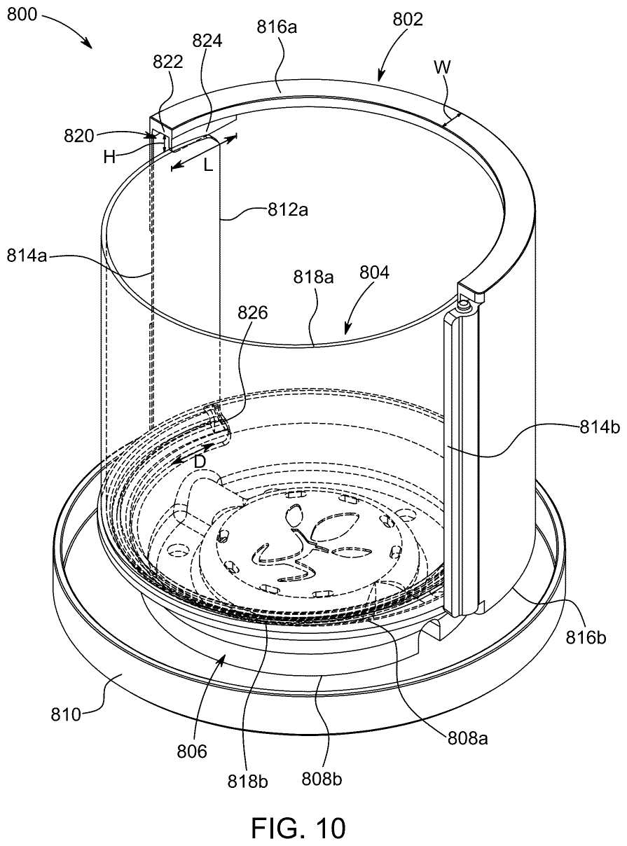

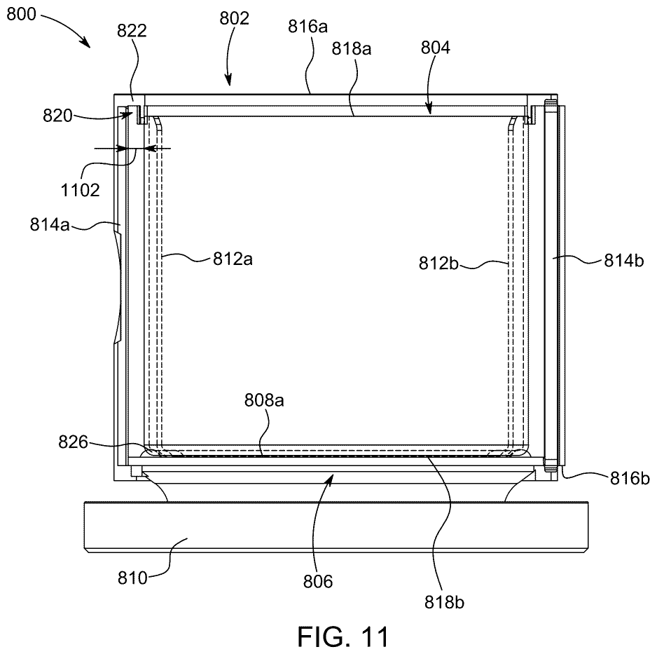

In some aspects, the pot body top portion 816a may include a slot 820 that may facilitate retaining of the transparent window 804 in the plant pot 800. The slot 820 may provide support to the transparent window top portion 818a and facilitate retaining of the transparent window 804 in the plant pot 800. The transparent window 804 may engage with the slot 820 located at the pot body top portion 816a when the transparent window 804 engages with the pot body 802. In some aspects, the transparent window top portion 818a may be inserted in the slot 820 to retain the transparent window 804, as shown in FIGS. 8 and 9. In other aspects, the transparent window top portion 818a may rest against the slot 820, as shown in FIGS. 10 and 11. The details of the slot 820 and the engagement of the transparent window 804 with the slot 820 are described below.

In some aspects, the pot body top portion 816a may include a lip 822. The lip 822 may be formed as a continuous horizontal projection along an entire perimeter of the pot body 802 (or the pot body top portion 816a). The lip 822 may be formed at a top edge of the pot body 802. The lip 822 may project inwards (e.g., horizontally towards an interior portion of plant pot 800) from a pot body wall at the top edge of the pot body 802, to create a continuous boundary at the pot body top portion 816a. For instance, when the pot body 802 is a semi-circular in shape, the lip 822 may also be a semi-circular projection/boundary at the pot body top portion 816a. In some aspects, the lip 822 may be an integrated part of the pot body 802. The lip 822 may have any dimensions. For instance, the lip 822 may have a width “W” that may range from 2% to 10% of the pot body outer diameter.

The pot body top portion 816a may further include a retainer 824 that may extend vertically from the lip 822 to form the slot 820. The retainer 824 may be a vertical wall that may extend downwards from a side edge of the lip 822 to form an inverted U-shaped slot at the pot body top portion 816a. Two retainers 824 may be located in proximity to the side edges 814a, 814b of the pot body 802, to form two inverted U-shaped slots in proximity to the side edges 814a, 814b. The retainer 824 may not extend continuously along the entire perimeter of the pot body 802 like the lip 822. In some aspects, the retainer 824 may be an integrated part of the lip 822, and may be formed through injection molding. Alternatively, the retainer 824 may be removably attached to the side edge of the lip 822. The retainer 824 may have any dimensions. For instance, the retainer 824 may have a height “H” that may range from 3% to 15% of the pot body height plus pot base height, and a length “L” that may range from 5% to 25% of the pot body outer diameter.

The retainers 824 and the lip 822 may form openings (inverted U-shaped openings) or slots 820 in proximity to the side edges 814a and 814b of the pot body 802. In an exemplary aspect (or in a “first configuration”), the transparent window 804 (or the transparent window top portion 818a) may be inserted inside the slot 820 (or the inverted U-shaped slot) to engage the transparent window 804 with the pot body 802. Specifically, when the transparent window 804 and the pot body 802 are positioned on the base upper portion 808a, the side edges 812a, 812b of the transparent window 804 may overlap with the side edges 814a, 814b of the pot body 802. In this case, the transparent window top portion 818a may be inserted inside the slot 820. When the transparent window 804 is inserted inside the slot 820, the transparent window top portion 818a may be located between the retainer 824 and the wall of the pot body 802. In this manner, the slot 820 enables the transparent window 804 to engage with the pot body 802 and retain in the plant pot 800.

In some aspects, the plant pot 800 may further include one or more stoppers 826 (a positive stop) that may be located on the base upper portion 808a The two stoppers may be located in proximity to the side edges 814a, 814b of the pot body 802. For instance, the stoppers 826 may be located at a distance “D” from the side edges 814a, 814b of the pot body 802. The distance “D” may range from 0% to 25% of the pot body outer diameter. The stoppers 826 may define a maximum insertion distance of the side edges 812a, 812b of the transparent window 804 into the pot body 802. Stated another way, the stoppers 826 limits the insertion of the transparent window 804 (or the side edges 812a, 812b) inside the side edges 814a, 814b of the pot body 802 beyond a predefined point defined by the distance “D”. In this manner, the stoppers 826 prevents insertion of the transparent window 804 into the pot body 802 beyond the distance “D”.

FIG. 9 depicts a front view of the plant pot 800 in the first configuration in accordance with the present disclosure. Specifically, FIG. 9 depicts the front view of the plant pot 800 when the transparent window 804 is inserted inside the slot 820. As shown in the FIG. 9, the side edges 812a, 812b of the transparent window 804 may align with the side edges 814a, 814b of the pot body 802 when the plant pot 800 is in the first configuration, to prevent leakage of soil/water from the interior portion of the cylindrical structure formed by the pot body 802 and the transparent window 804.

FIG. 10 depicts an isometric view of the plant pot 800 in a second configuration in accordance with the present disclosure. FIG. 10 is described in conjunction with FIG. 11. In this configuration, the transparent window 804 (or the transparent window top portion 818a) may not be inserted inside the slot 820, but may rest against the slot 820 to form a ventilation channel 1102 (shown in FIG. 11) along the side edges 814a, 814b of the pot body 802. Specifically, the transparent window 804 may rest on the retainer 824 to form the ventilation channel 1102 when the plant pot 800 is in the second configuration. The retainer 824 may have a retainer interior surface and a retainer exterior surface. The retainer interior surface may face the wall of the pot body 802 and the retainer exterior surface may face the interior portion of the plant pot 800. The transparent window 804 may rest on the exterior surface of the retainer 824 to form the ventilation channel 1102, as shown in FIGS. 10 and 11. In the second configuration, the transparent window bottom portion 818b may rest on front, on top of, or against the side of the stoppers 826.

It may be appreciated that the ventilation channel 1102 in the plant pot 800 enhances root-zone aeration by allowing fresh air to circulate through the soil profile, which helps maintain an optimal balance of oxygen and moisture around the roots. This improved airflow prevents soil compaction, reduces the risk of root rot caused by excessive water retention, and supports healthier microbial activity that contributes to nutrient availability. By facilitating faster evaporation of excess moisture, the ventilation channel 1102 also aids in regulating soil temperature and promotes stronger, more resilient root development, ultimately leading to healthier plant growth and reduced maintenance issues.

In operation, a user may switch between the plant pot's first configuration and the second configuration based on requirements. As described above, in the first configuration, the transparent window top portion 818a may be inserted inside the slot 820 to retain the transparent window 804 (to prevent any leakage of water). In the second configuration, the transparent window top portion 818a may rest against the slot 820 (to form the ventilation channel 1102). It may be appreciated that the requirement for root-zone ventilation is species-dependent and governed by the plant's physiological tolerance to oxygen availability in the rhizosphere. Xerophytic and many ornamental indoor species exhibit higher demand for aerated substrates, relying on rapid gas exchange to prevent hypoxic stress and mitigate moisture accumulation that can induce root decay. In contrast, hydrophytic and mesophytic species adapted to saturated or high-moisture environments demonstrate low sensitivity to reduced oxygen concentrations and do not require supplemental ventilation, as their root systems are physiologically optimized for anaerobic or low-aeration conditions. The user may switch the configuration based on the plant species type that is present in the interior portion of the plant pot 800.

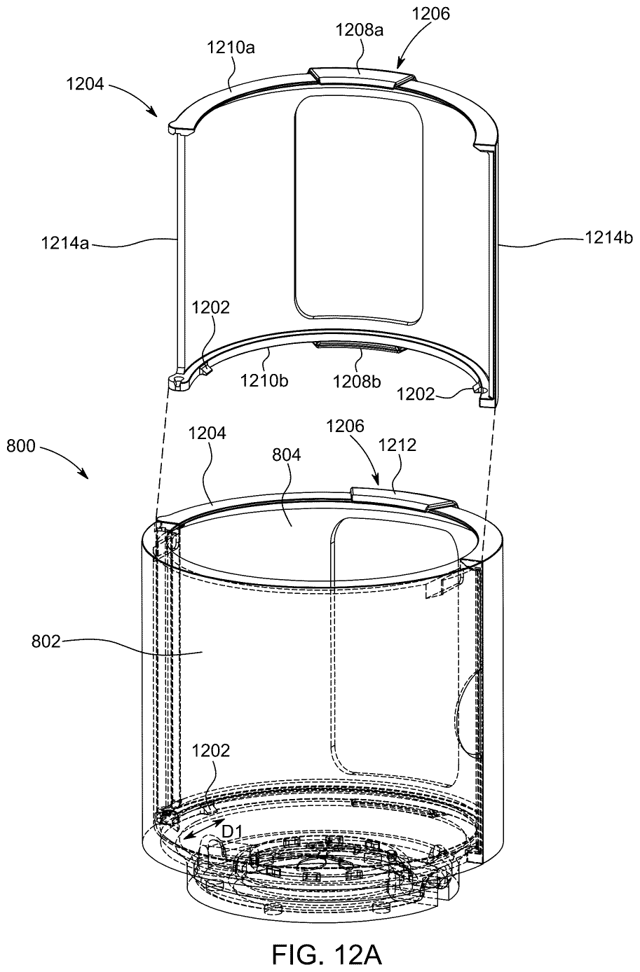

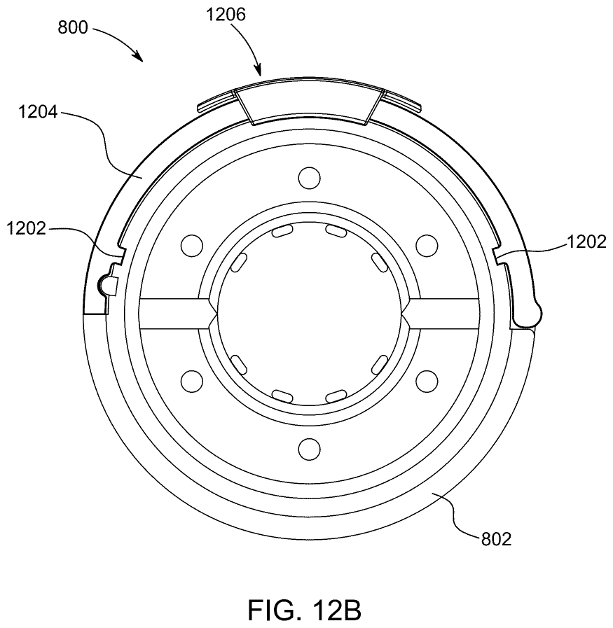

FIGS. 12A and 12B depict the plant pot 800 with door stoppers 1202 in accordance with the present disclosure. FIG. 12A depicts the isometric view of the plant pot 800 (and a separate view of a door 1204), and FIG. 12B depicts the bottom view of the plant pot 800. The plant pot 800 may include the door 1204 that may be the same as the door 116 described above in conjunction with FIG. 1. The door 1204 may be attached to the pot body 802, and configured to cover or uncover the transparent window 804. The door 1204 may cover an outer face (or front portion/exterior surface) of the transparent window 804. The door 1204 may be a semicircular body having dimensions similar to the dimensions of the transparent window 804, and may be configured to completely cover/surround/enclose the transparent window 804.

In some aspects, the door 1204 may be made of an opaque material that prevents light from passing through. The door 1204 may prevent light from passing through the transparent window 804 when the transparent window 804 is completely covered by the door 1204. The user may uncover the transparent window 804 by opening the door 1204, to view the soil state or roots through the transparent window 804. In an exemplary aspect, the door 1204 may be pivotally attached to the pot body 802 via a hinge (as described above in conjunction with FIG. 1), and may cover or uncover the transparent window 804. The door 1204 may move between a door closed state and a door open state. In the closed state, the door 1204 may be placed over the transparent window outer surface to cover the transparent window 804 to enable the roots to grow in a dark environment. In the open state, the door 1204 may uncover the transparent window 804 to enable the user to see the soil state or plant root state.

The door 1204 may include a cut-out (e.g., the cut-out 122 described above in conjunction with FIG. 1) that may be located at any position on the door body. The plant pot 800 may include a shade 1206 that may be the same as the shade 124 described above in conjunction with FIG. 1. The shade 1206 may cover or uncover the cut-out of the door 1204. The shade 1206 may slide on the door 1204 between a shade open state and a shade closed state to cover or uncover the cut-out. The shade 1206 may slide to an end of the door 1204 to enable the user to view the soil state conveniently (e.g., when the user moves the shade 1206 to the shade open state), without having to open the door 1204 and view the soil state or roots via a completely-open transparent window 804.

The shade 1206 may have a shade upper edge 1208a and a shade lower edge 1208b, as shown in FIG. 12A. In some aspects, the shade upper edge 1208a may be positioned in proximity to a door upper edge 1210a, and the shade lower edge 1208b may be positioned in proximity to a door lower edge 1210b. The shade 1206 may include a bracket 1212 (e.g., an “L-shaped” bracket or a “U-shaped” bracket, similar to the bracket 132 described above in conjunction with FIG. 1) that may engage with a rail (e.g., the rail 130 described above in conjunction with FIG. 1) and/or the lip 822 that enables the shade 1206 to attach with the door 1204, and slide between the shade open state and the shade closed state. In one exemplary aspect, the bracket 1212 may be located at (or towards) the shade upper edge 1208a and/or the shade lower edge 1208b, which enables the shade 1206 to removably connect to the door 1204 at the door upper edge 1210a and/or the door lower edge 1210b. The shade 1206 may snap or latch with the door 1204, via the bracket 1212, enabling the shade 1206 to be removably connected with the door 1204, while at the same time enabling the shade 1206 to easily slide between the shade open state and the shade closed state.

The plant pot 800 may include the door stoppers 1202 that may be located in the door 1204. In some aspects, the door 1204 may include two stoppers that may be located in proximity to the door lower edge 1210b. In further aspects, the door stoppers 1202 may be located in proximity to the door upper edge 1210a as well. The two door body stoppers may be located in proximity to the side edges 1214a, 1214b of the door 1204. For instance, the door stoppers 1202 may be located at a distance “D1” from the side edges 1214a, 1214b of the door 1204. The distance “D1” may range from 0% to 30% of the door outer diameter. The door stoppers 1202 may prevent sliding of the shade 1206 beyond a specific point.

In some aspects, the door stoppers 1202 may be protrusions that may be projected from an interior surface of the door 1204 towards the interior portion of the plant pot 800, as shown in FIGS. 12A and 12B. The brackets 1212 may contact the door stoppers 1202 when the shade 1206 is slid beyond a specific distance. When the brackets 1212 contact the door stoppers 1202, the shade 1206 cannot be slid further. In this manner, the door stoppers 1202 act as positive stops for the shade 1206.

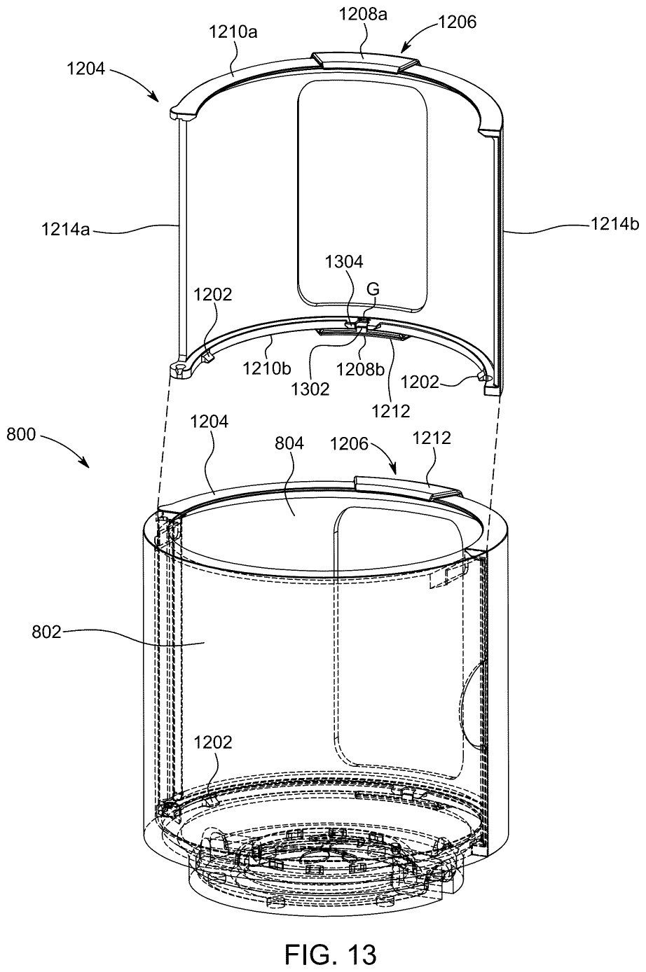

FIG. 13 depicts the shade 1206 and the door 1204 with detents to engage the shade 1206 with the door 1204 (and a separate view of the door 1204) in accordance with the present disclosure. In some aspects, the shade 1206 includes a first detent 1302 and the door 1204 includes a second detent 1304. The first detent 1302 may engage with the second detent 1304 to enable the shade 1206 to be positioned at a center portion of the door 1204 to cover the cut-out. In some aspects, the first detent 1302 may be located at a center portion of the bracket 1212 located at the shade upper edge 1208a and/or the shade lower edge 1208b. The second detent 1304 may be located at the door upper edge 1210a and/or the door lower edge 1210b.

The second detent 1304 may include two protrusions at a predefined distance. Stated another way, there is a gap “G” between the protrusions of the second detent 1304. The gap “G” may correspond to the width of the first detent 1302. The first detent 1302 may be inserted in the gap “G” to engage the first detent 1302 with the second detent 1304. When the first detent 1302 engages with the second detent 1304, the shade 1206 is positioned at a center portion of the door 1204 to cover the cut-out.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A plant pot comprising:
a base having a base upper portion and a base lower portion, wherein the base is circular in shape;
a pot body attached to a first predefined part of a perimeter of the base upper portion, wherein the pot body comprises a pot body top portion and a pot body bottom portion, and wherein the pot body top portion comprises a slot;
a transparent window attached to a second predefined part of the perimeter of the base upper portion, wherein the transparent window engages with the pot body to define a housing of the plant pot, and wherein the transparent window is configured to engage with the slot located at the pot body top portion when the transparent window engages with the pot body; and
a door attached to the pot body, wherein the door is configured to move between a door open state and a door closed state to cover or uncover the transparent window.

2. The plant pot of claim 1, wherein the pot body top portion comprises a lip that is formed as a continuous projection extending along an entire perimeter of the pot body.

3. The plant pot of claim 2, wherein the pot body top portion further comprises a retainer that extends vertically from the lip to form the slot.

4. The plant pot of claim 3, wherein the retainer is located in proximity to a pot body side edge.

5. The plant pot of claim 3, wherein the retainer does not extend continuously along the entire perimeter of the pot body.

6. The plant pot of claim 4, wherein the retainer and the lip forms an inverted U-shaped slot at the pot body side edge.

7. The plant pot of claim 6, wherein the transparent window is configured to be inserted inside the inverted U-shaped slot to engage the transparent window with the pot body.

8. The plant pot of claim 6, wherein the transparent window is configured to rest against the inverted U-shaped slot to form a ventilation channel along the pot body side edge.

9. The plant pot of claim 8, wherein the transparent window is configured to rest against an exterior surface of the retainer to form the ventilation channel.

10. The plant pot of claim 1, wherein the transparent window is removably attached to second predefined part of the perimeter of the base upper portion.

11. The plant pot of claim 1, wherein the pot body comprises a pot body side edge and the transparent window comprises a transparent window side edge, and wherein the pot body side edge overlaps with the transparent window side edge when the transparent window engages with the pot body.

12. The plant pot of claim 11, wherein the base upper portion comprises a stopper configured to define a maximum insertion distance of the transparent window side edge in the pot body.

13. The plant pot of claim 12, wherein the stopper is located in proximity to the pot body side edge.

14. The plant pot of claim 1, wherein the door comprises a cut-out.

15. The plant pot of claim 14 further comprising a shade configured to uncover or cover the cut-out.

16. The plant pot of claim 15, wherein the shade is configured to slide between a shade open state and a shade closed state to uncover or cover the cut-out.

17. The plant pot of claim 15, wherein the door comprises a door upper edge and a door lower edge, and wherein the door lower edge comprises a door stopper to prevent sliding of the shade beyond a specific point.

18. The plant pot of claim 15, wherein the shade comprises a first detent and the door comprises a second detent to enable the shade to be positioned at a center portion of the door to cover the cut-out.

19. A plant pot comprising:
a base having a base upper portion and a base lower portion, wherein the base is circular in shape;
a pot body attached to a first predefined part of a perimeter of the base upper portion, wherein the pot body comprises a pot body top portion and a pot body bottom portion, and wherein the pot body top portion comprises a slot;
a transparent window attached to a second predefined part of the perimeter of the base upper portion, wherein the transparent window engages with the pot body to define a housing of the plant pot, wherein the transparent window is configured to engage with the slot located at the pot body top portion when the transparent window engages with the pot body, and
wherein the base upper portion comprises a stopper configured to define a maximum insertion distance of a transparent window side edge in the pot body; and
a door attached to the pot body, wherein the door is configured to move between a door open state and a door closed state to cover or uncover the transparent window.

20. A plant pot comprising:
a base having a base upper portion and a base lower portion, wherein the base is circular in shape;
a pot body attached to a first predefined part of a perimeter of the base upper portion, wherein the pot body comprises a pot body top portion and a pot body bottom portion, and wherein the pot body top portion comprises a slot;
a transparent window attached to a second predefined part of the perimeter of the base upper portion, wherein the transparent window engages with the pot body to define a housing of the plant pot, and wherein the transparent window is configured to engage with the slot located at the pot body top portion when the transparent window engages with the pot body;
a door attached to the pot body, wherein the door is configured to move between a door open state and a door closed state to cover or uncover the transparent window, wherein the door comprises a cut-out; and
a shade configured to slide between a shade open state and a shade closed state to uncover or cover the cut-out,
wherein the door comprises a door top portion and a door bottom portion, and wherein the door bottom portion a door stopper to prevent sliding of the shade beyond a specific point.
